(19) United States
(12) Patent Application Publication
(10) Pub. No.: US 2009/0283281 A1
(43) Pub. Date: Nov. 19, 2009

(54) Multipurpose gardening and weeding tool that enables the user to easily and effectively remove dandelions and other unwanted weeds in and around yards, around shrubbery, and in and around vegetable and flower gardens

(76) Inventor: James Herbert Lewis, Florence, KY (US)

Correspondence Address: James Lewis, 211 Burgess Lane, Florence, KY, 41042, US

(21) Appl. No.: 11/818,980

(22) Filed: Jul. 27, 2007

(51) Int. Cl. A01B 1/20; A01B 1/02; A01B 1/06

(52) U.S. Cl. 172/375

(57) ABSTRACT

My invention is a multipurpose gardening and weeding tool that reduces the effort of effectively getting rid of weeds, dandelions, and other unwanted vegetation while the user is in an upright standing position. The user places the split tipped end of the tool close to the base of the plant or weed and inserts the tool vertically at the base of the weed. Additional insertion force can be applied by stepping on the heart shaped blade. As the blade becomes the fulcrum, the leverage force removes the weed and its root(s). This very sturdy, uncomplicated tool will enable people working in yards or gardens or around shrubbery to effectively get rid of the unwanted vegetation, roots and all, while the user remains in a standing position. This tool can also be used to prepare the soil to cultivate vegetable gardens and flower gardens and as a hoe to work around individual plants or rows of plants.

The present invention is a tool which enables the user to easily and effectively remove dandelions and other unwanted weeds and vegetation in and around yards, around shrubbery, and in and around vegetable and flower gardens.

This multipurpose gardening and weeding tool is made up of three parts that are welded together to form the tool unit. One end of the ⅜ inch square steel shaft has a slightly curved split tip which is the end that is inserted into the ground during both the weed removal and soil preparation processes. The heart shaped blade of the tool is welded onto the opposite side of the curved split tipped end of the shaft about 4 (four) inches back from the slightly curved tapered point end of the shaft. The heart shaped blade with its attaching appendage become part of the shaft metal shaft. When the other end of the ⅜ inch steel shaft, that extends about 6 or 7 inches beyond where the heart shaped blade is attached, is inserted into a long handle the tool then becomes one unit.

This multipurpose gardening and weeding tool is made from 3 pieces of tempered steel; the ⅜ inch square shaft, the heart shaped blade and the connecting appendage which are welded together to form the metal part of the tool. It is the flattened split tipped, slightly curved end of the shaft that is inserted into the ground. The other end of the shaft is inserted firmly and securely into an approximately 50 inch handle. The heart shaped blade is positioned on the opposite side of the split tipped end of the shaft about 4 (four) inches away from the split tipped end of the shaft. The metal shaft with the split tipped end and the attaching appendage for the heart shaped blade when welded together become the same piece of metal (FIG. 1). When the other end of the metal shaft is inserted into the end of a 50 inch wooden handle it then becomes the completed tool (FIG. 2).

The manufacturing technology required for the production of a tool like this is well developed. This multifunctional gardening and weeding tool could easily be produced at a competitive production cost and pricing structure much like other uncomplicated, easy to use tools which are currently being manufactured and sold.

First—While firmly holding the multifunctional gardening and weeding tool by the handle 4 the user positions the flattened split tipped end 2 of the shaft 1 in close proximity to the base of the weed or dandelion in a nearly vertical insertion position (FIG. 3).

Second—If the ground is fairly hard the user can apply additional insertion force as needed by stepping on the heart shaped blade 3 with one foot to force the insertion of the shaft 1 with the flattened split tip 2 into the ground in close proximity to the base of the weed and its root system (FIG. 4).

Third—After the shaft is inserted and the user pulls back on the handle 4 in the direction of the side of the tool where the heart shaped blade 3 is situated, the heart shaped blade then becomes the fulcrum which will generate the leverage force which will enable the user to easily remove the weed or dandelion or other unwanted vegetation along with their root systems from the ground while the user remains in a standing position (FIG. 5). This same action and procedure is used to prepare soil in irregular shaped areas or in rows for planting and cultivating. (FIG. 8, FIG. 8a and FIG. 8b)

Fourth—If the weed or plant has a shallow, bushy root system similar to crabgrass, the user will have to make 2 or 3 additional insertions of the flattened split tipped end 2 of the shaft 1 to disrupt the soil under the plant or weed where the root(s) will be located. The user can then remove the weed or plant and the root(s) by placing the pointed round end of the heart shaped blade 3 component of the tool into the soil at the base of the weed or plant where the soil has been disrupted by the insertion of the flattened split tipped end of the tool (FIG. 6). The user can apply the removal force needed to extract the weed, root(s) and all, by pulling back on the handle 4 of the tool which will force the weed and its root(s) out of the soil using the blade component of the multifunctional gardening and weeding tool (FIG. 7). This tool can also be used to prepare the soil to cultivate vegetable gardens and flower gardens.( FIG. 8, FIG. 8a and FIG. 8b)

### DRAWINGS

FIG. 1) Shows the dimensions of the tool and how the tool is assembled.

FIG. 2) Shows a side view of the tool

FIG. 3) Shows how the tool is positioned close to the base of a plant or weed.

FIG. 4) If additional force is need to penetrate the soil the user can step on the blade

FIG. 5) How an unwanted weed or plant can be uprooted with this tool

FIG. 6) Shows how the blade can be used like a hoe to remove weeds

FIG. 7) Shows how weeds and other plants can be removed from the soil

FIGS. 8, 8a, 8b) Shows how the tool can be used to prepare the soil for cultivation

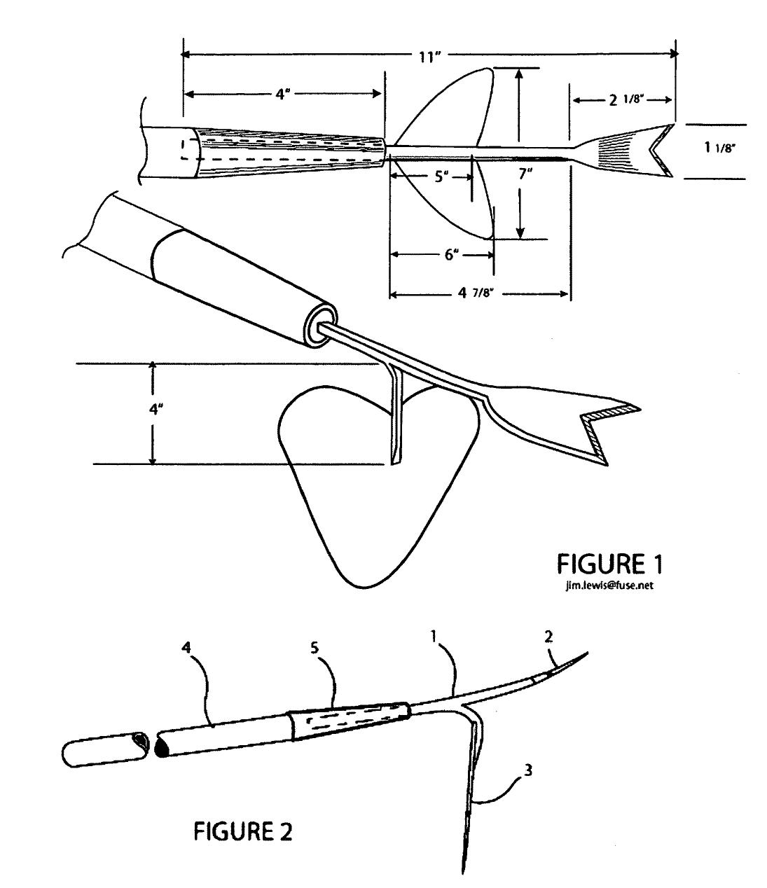

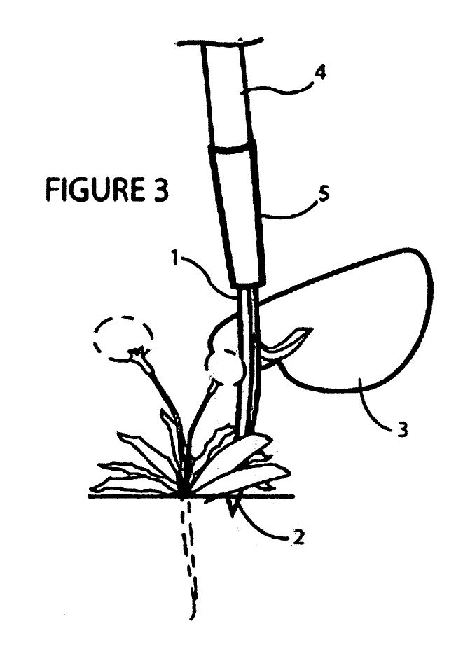

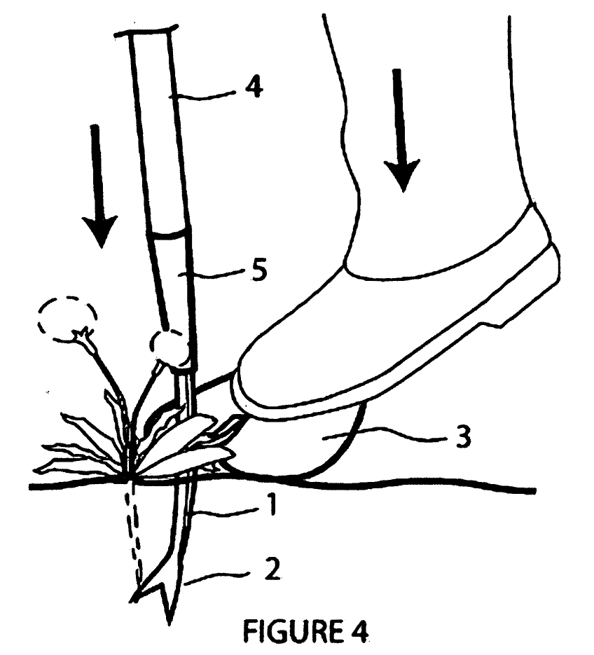

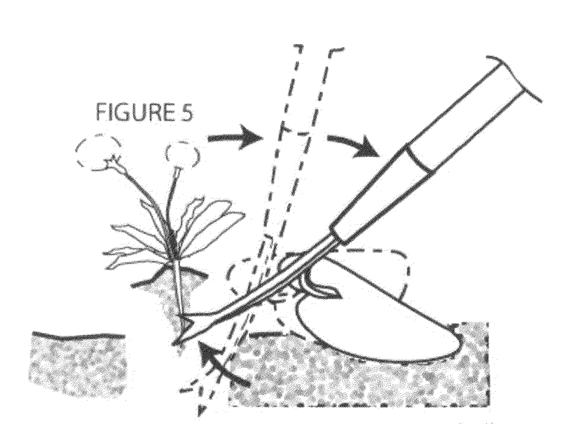

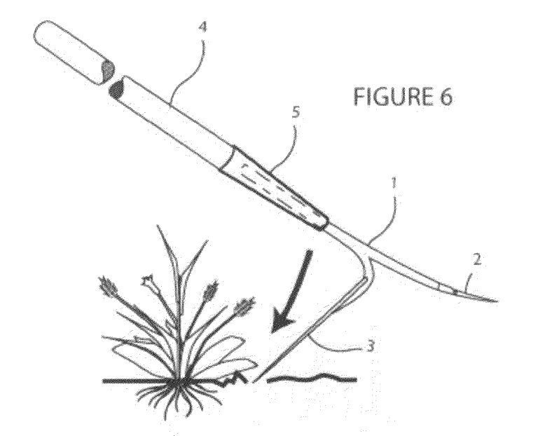

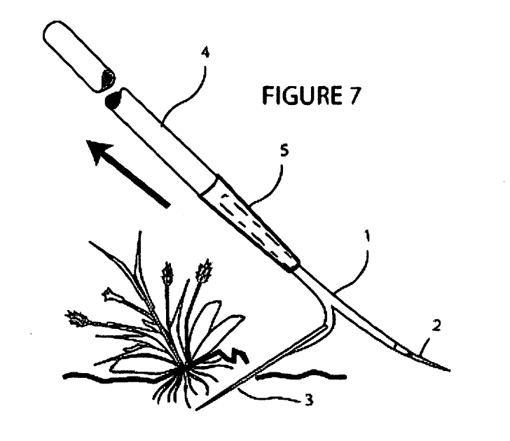

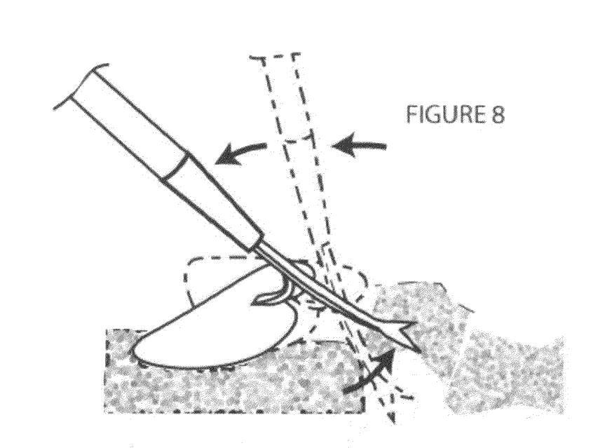

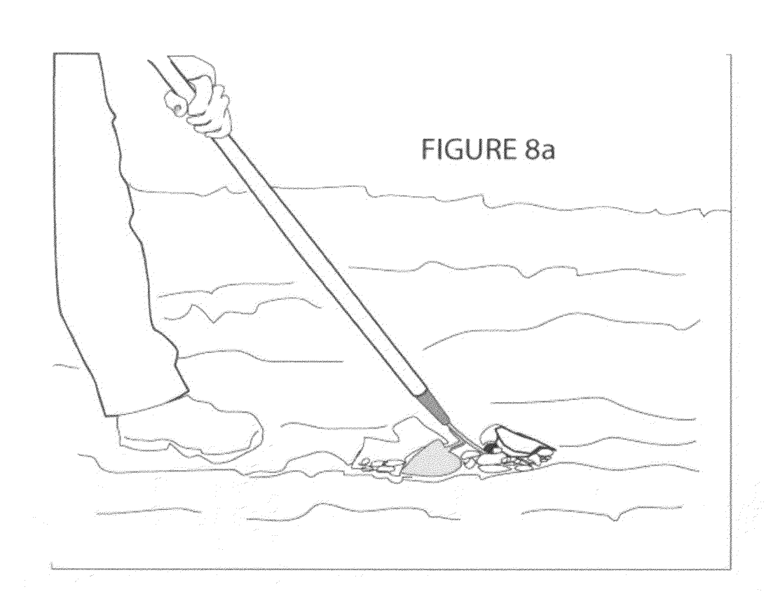

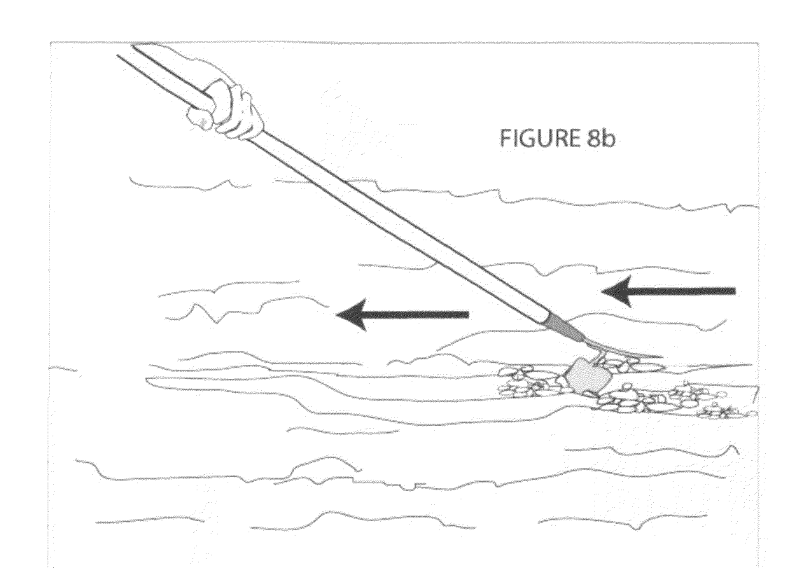

I hereby claim:

1. The way this invention works is by reducing the effort of getting rid of weeds, dandelions, and other unwanted vegetation. The pointed shaft of the tool is inserted at a nearly vertical angle at the base of the weed or dandelion and by the use of leverage from an upright standing position the unwanted vegetation can be removed. Additional insertion force can be applied by using the foot to step on the heart shaped blade which acts as the fulcrum for the end of the tool that is in the ground. While standing in an upright position the user creates removal force by pulling back on the handle of the tool while the heart shaped blade, which is an integral part of the tool, acts as the fulcrum, thus creating the leverage needed for removal of the weed or dandelion.

2. This is a very simple, easy to use multipurpose gardening and weeding tool will enable people working in their yards or their vegetable or flower gardens and around shrubbery to effectively get rid of weeds, dandelions and other unwanted plants with little effect on other plants and vegetation close by and without the need to use toxic chemicals to do so.

3. With this tool the user will be able to easily and effectively remove dandelions and other unwanted weeds in and around yards, around shrubbery, and in and around vegetable and flower gardens.

4. This sturdy, uncomplicated multifunctional tool will reduce the effort of getting rid of weeds, dandelions, and other unwanted vegetation with minimal bending while the user remains in a standing position.

5. The split end of the shaft of the tool is positioned by the user for insertion into the soil at the base of the unwanted vegetation such as weeds and dandelions at a nearly vertical angle. Additional entry force can be applied by using the foot to step on the heart shaped blade to fully insert the flattened split end of the shaft of the tool into the ground. When the flattened split tip of the shaft is in the ground close to the root(s) of the plant or weed, the heart shaped blade becomes the fulcrum for the flattened split tipped end of the tool that has been inserted into the ground.

6. When the heart shaped blade, which is an integral part of the tool, becomes the fulcrum, the leverage force needed for removal of the weeds, dandelions or other unwanted vegetation is created.

7. While standing in an upright position the operator creates the removal force by pulling back on the handle of the multipurpose tool. By using this leverage force from an upright standing position the user can uproot and extract and remove the unwanted vegetation, dandelions, and other weeds with ease.

8. This tool can also be used to prepare the soil to cultivate vegetable gardens and flower gardens and as a hoe to work around individual plants or rows of plants.
